(19) United States
(12) Patent Application Publication
(10) Pub. No.: US 2008/0055822 A1
(43) Pub. Date: Mar. 6, 2008

(54) SCALABLE PLANT WITH TOP OR BOTTOM ENTRY FLEXIBILITY

(75) Inventors: Donald P. Rearick, Rowlett, TX (US); James R. Walton, Terrell, TX (US); Richard D. Williams, Richardson, TX (US)

Correspondence Address: CARR LLP, 670 FOUNDERS SQUARE, 900 JACKSON STREET, DALLAS, TX, 75202, US

(73) Assignee: Valere Power, Inc., Richardson, TX (US)

(21) Appl. No.: 11/470,229

(22) Filed: Sep. 5, 2006

(51) Int. Cl. H02B 1/26

(52) U.S. Cl. 361/641

(57) ABSTRACT

A power distribution system. In one embodiment the system includes at least one rectifier cabinet, at least one distribution cabinet, and a pair of conductors. Each cabinet has a side wall which is adjacent to the side wall of the other cabinet. Further, the rectifier cabinet includes slots for rectifiers and the distribution cabinet has slots for distribution modules. The conductors are coupled to the cabinets. One of the conductors may terminate a first wire connected to a rectifier slot and may terminate a second wire connected to a distribution module slot. The other conductor may complete a DC return path to the rectifier cabinet. In one embodiment AC and DC cables may be routed through the top or the bottom of the cabinets. In another embodiment the conductors are bus bars positioned near the back of the cabinets. Rectifier and distribution cabinets and associated methods are also provided.

### TECHNICAL FIELD

The invention relates generally to power distribution systems and, more particularly, to alternating current (AC) to direct current (DC) power conversion and distribution systems.

### BACKGROUND

Telecommunication installations such as central offices and mobile telephone switching centers (MTSOs) as well as many other facilities, require highly reliable DC power systems. Needless to say, failure of the power system could disrupt the services offered by these facilities. Moreover, as demands change on these facilities (particular when traffic increases) the owners of the facilities often find themselves in need of reconfiguring the power systems. Thus, restrictions on how much overall power may be provided by a power system and restrictions on the mixture of individual power supplies within the system constrain the ability of the facility owners to meet shifting facility demands.

Typically, the suppliers of the high current power systems for these facilities build the systems into rack assemblies. The power rectifiers are installed in the bottom of the rack and the distribution equipment (e.g., circuit breakers, fuses, switches, etc) are stacked above the rectifiers in a “waterfall” configuration. In other words, the outgoing DC supply cables cascade down the stack of distribution equipment with one cable being terminated at each level of the waterfall. Since the cables enter the rack at the top, the cables which are terminated at the lower levels make it difficult to terminate any other cable at a position immediately above their respective terminals.

Unfortunately, the facility owners often find the top entry constraint inconvenient for other reasons. For instance, it may be that the existing facility cables may be near the bottom of the rack assembly. A computer room with a raised floor and cable chases under that floor serves as an example of this situation. Additionally, the shielding required to prevent electro magnetic interference (i.e., EMI) from crossing over between the AC and DC cables adds to the complexity and expense of the rack assembly. Moreover, because of the inflexible waterfall configuration the rack assemblies must be configured to meet the maximum expected power and distribution requirements associated with the facility over the life of the rack. However, as the facility evolves, the maximum requirements may exceed those that were expected when the rack assembly was configured. Furthermore, because of the fixed design of the rack assembly it is difficult, if not impossible, to modify the mix of rectification and distribution equipment in the rack assembly at a later time or in the field.

### SUMMARY OF THE INVENTION

In one embodiment of the invention, a power distribution system is provided, the system comprising: a rectifier cabinet including a plurality of slots for accepting rectifiers and a side wall; a distribution cabinet including a plurality of slots for accepting distribution modules and at least one side wall adjacent to the side wall of the rectifier cabinet; and at least a pair of conductors, each conductor being coupled to the cabinets, one of the conductors being adapted to terminate a first wire connected to a rectifier slot and to terminate a second wire connected to a distribution module slot, the other conductor being adapted to complete a direct current return path to the rectifier cabinet.

Advantageously, the present invention can provide a power system in which the rectifiers are separated into one cabinet and the distribution equipment is separated into another cabinet. Further, the rectifiers and distribution equipment can be modular in nature with common sizes, contacts, and appropriate surge suppression features that allow hot swapping. These modules may be installed in slots in the appropriate cabinet to modify the mixture of capabilities provided by the system. Thus, one advantage of the current embodiment is that it enables system expansion by the addition of rectifier and distribution modules. Additionally, the system of the current embodiment allows adding cabinets to meet changing power requirements. As a result, the system is flexible and can fit into existing facilities with little, or no, facility re-wiring. For example, in one exemplary configuration, the system may be expanded to 10,000 amp capacity. Furthermore, the system may include the rectifier slots in the bottom of the rectifier cabinet and an AC wiring compartment positioned above the rectifiers. In addition to having front access panels, the cabinets may be configured so that the rectifier cabinet can be installed to either the right side or the left side of the distribution modules.

The present invention can also provide a system that includes a rectifier cabinet, a distribution cabinet, and a pair of conductors. Each cabinet can have a side wall which is adjacent to the side wall of the other cabinet. Further, the rectifier cabinet can includes slots for rectifier modules and the distribution cabinet can have slots for distribution modules. The conductors can be coupled to the cabinets. One of the conductors may terminate a first wire connected to a rectifier slot and may terminate a second wire connected to a distribution module slot. The other conductor may help complete a DC return path to the rectifier cabinet.

The present invention can also allow the conductors to be bus bars positioned near the back of the cabinets. The present invention can also allow the AC and DC cables to be routed through an entry at either the top or the bottom of the cabinets. Rectifier and distribution cabinets and associated methods can also be provided by the present invention.

The present invention can also provides a rectifier cabinet for use with a distribution cabinet. The rectifier cabinet can include a plurality of slots for accepting rectifiers and at least two pairs of terminals which are connected to the rectifier slot. The first pair of terminals can be provided for terminating the incoming AC supply wires. The second pair of terminals can be provided for terminating the outgoing DC supply wires. These pairs of terminals can be pre-wired to the rectifier slot. Further, the rectifier cabinet can be adapted in such a manner that when used with the distribution cabinet, the cabinets are adjacent to each other. Moreover, the rectifier cabinet may define a wiring compartment above the rectifier slots. The terminals may also be part of a termination panel which is accessible through a front panel of the cabinet. Further, either the top of the cabinets, the bottom of the cabinets, or both may define an entry through which the AC supply cables may be routed. Moreover, the rectifier cabinet may have a back wall on which a pair of external terminals may be positioned. These external terminals may be connected to the DC terminals via field wiring. The rectifier cabinet may also include a battery distribution bay.

The present invention can also provide a distribution cabinet for use with a rectifier cabinet. The distribution cabinet can include a plurality of slots for accepting distribution modules, a pair of terminals, and a return terminal. The pair of terminals can be for a corresponding pair of DC wires and can be connected to a distribution module slot. The return terminal can be for completing a DC return path to the rectifier cabinet. Further, the distribution cabinet can be adapted in such a manner that when the distribution cabinet is used with the rectifier cabinet the cabinets are adjacent to each other.

The invention can also allow the distribution cabinet to include a wiring compartment adjacent to the distribution module slots. Further, the distribution cabinet may include a termination panel including at least the pair of DC terminals on it. Additionally, the termination panel may be accessible via a front access panel.

The invention can also allow either the top of the cabinet, the bottom of the cabinet, or both to define an entry through which DC wires may be routed. The invention can also allow the cabinet to include a back wall on which a pair of external terminals are located. These external terminals may be connected to the pair of terminals and the return terminal via, for example, field wiring.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an orthogonal perspective view of a power system in accordance with the prior art.

FIG. 2A illustrates an elevation view from the front of the prior art system of FIG. 1.

FIG. 2B illustrates a cross sectional view of the system of FIG. 2A as seen along the line 2B-2B.

FIG. 3 illustrates an orthogonal perspective view of a power system constructed in accordance with an embodiment of the present invention, with the cover removed.

FIG. 4 illustrates an elevation view of the system of FIG. 3, as viewed from the front.

FIGS. 5A-C illustrate simplified schematics of the system of FIG. 3.

FIGS. 6A-D illustrate front elevation views of different configurations of exemplary power systems constructed in accordance with embodiments of the present invention.

FIGS. 7A-D illustrate front elevation views of still other configurations of exemplary power systems constructed in accordance with embodiments of the present invention.

FIG. 8A-C illustrate perspective views of the bus bars of the power system of FIG. 1.

### DETAILED DESCRIPTION

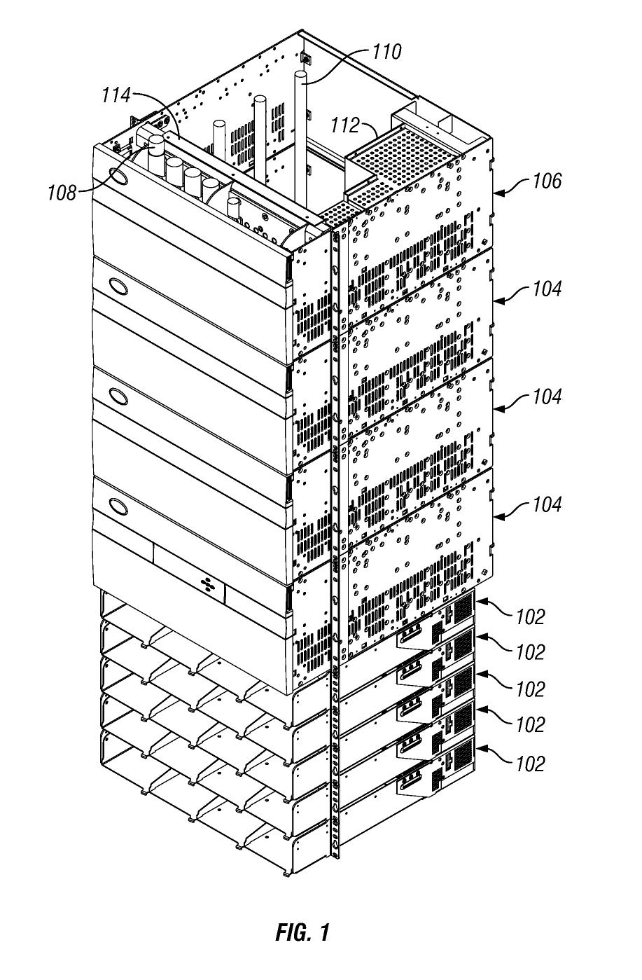

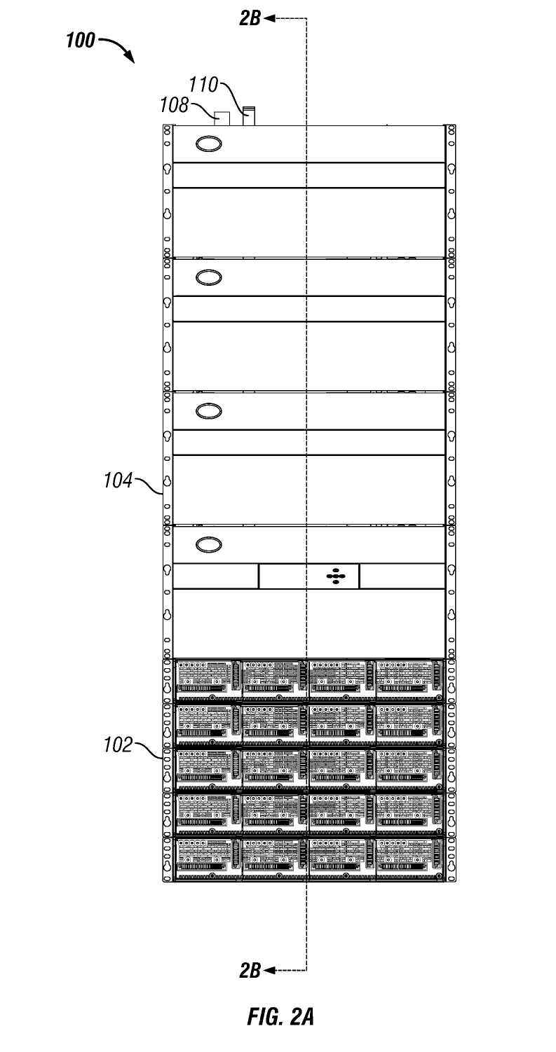

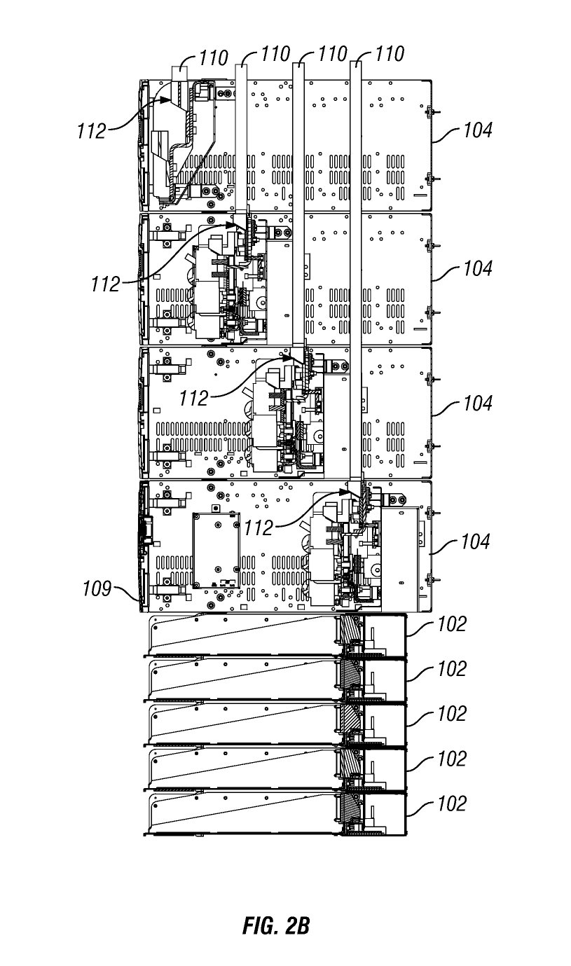

Referring to FIGS. 1, 2A and 2B of the drawings, the reference numeral 100 generally designates a power system in accordance with the prior art. The system 100 includes numerous shelves for rectifiers 102, power distribution equipment in a series of bays 104, and battery distribution bay 106. The rectifiers 102 are positioned below the distribution equipment 104 and with their terminals oriented about 90 degrees from the orientation of the distribution equipment terminals. Both the rectifiers 102 and distribution equipment 104 are essentially permanently mounted in the rack. Pairs of AC wires supply power to the cabinets via the rectifiers 102. These AC supply wires originate in the facility and Are connected to rectifier shelves 102 typically by being run through a conduit outside of the system.

The rectifiers 102 convert the AC power to DC power with appropriate characteristics (for example, meeting the appropriate ripple voltage specification with internal filters) for the equipment to be powered by the system 100. From the rectifiers 102, the DC power flows via hardwired cabling to the power distribution equipment 104. Then, DC power flows via DC wires or cables 110, which is routed from the system 100 via the top entry 112, and then to the equipment to be connected to and powered by the system 100. The DC wires originate in the facility and cascade down the back of the distribution modules for termination in the field. Furthermore, if the rack includes a battery distribution bay, the DC power may also be routed to the battery distribution bay 106 to charge batteries connected via battery wires 108 to the system 100. FIG. 2 shows that the DC wires 110 (and battery wires 108) are connected to terminals 112 on the distribution equipment. Additionally, FIG. 2A shows that the system 100 may include a controller 100 for controlling the system 100.

The rectifiers 102, the distribution equipment 104, and the battery distribution equipment 106 are pre-selected based upon the maximum power requirements that are expected for the system 100. These pieces of equipment 102, 104, and 106 can be then mounted to the rack and hardwired into the system 100. Accordingly, once the system 100 has been assembled it becomes difficult and expensive to reconfigure the equipment 102, 104, and 106 to meet changing power requirements. Moreover, because the system 100 routes all of the DC cables 108 and 110 through the entry 112 in relatively close proximity to one another, the ability to terminate other cables is hindered. Furthermore, because the cables 108 and 110 must enter the system 100 via the top entry 112, the system 100 allows little flexibility for facilities in which the cables 108 and 110 pre-exist the installation of system 100. That is, if the cables 108 and 110 are located near the bottom of the location for the system 100 (e.g., in a room with a raised floor having a cable chase there under), the facility must be re-wired to accommodate the new system 100.

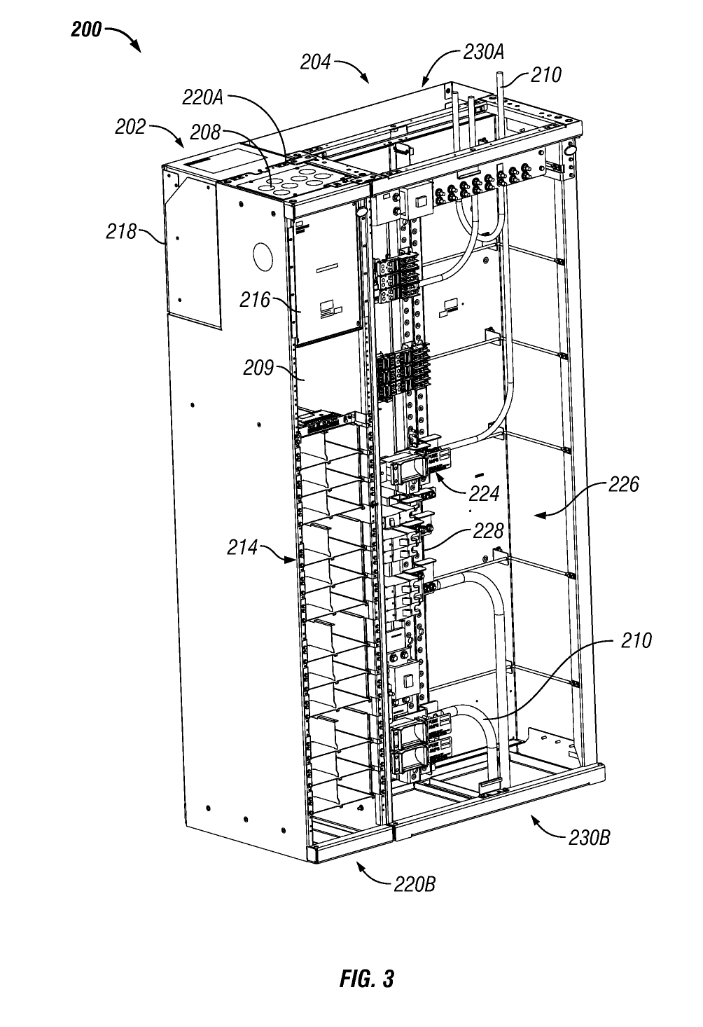

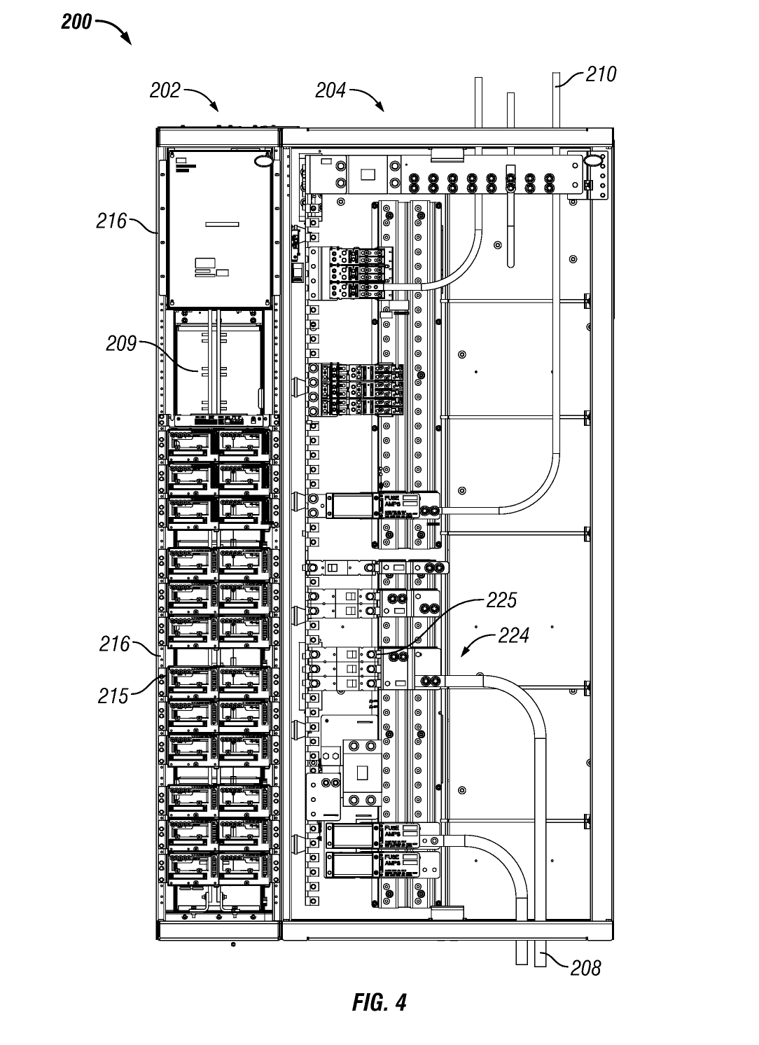

With reference now to FIGS. 3 and 4, a power distribution system 200 constructed in accordance with the principles of the present invention is illustrated, which overcomes most if not all of the foregoing difficulties with the prior art power system 100. In one embodiment, the system 200 can include a rectifier cabinet 202 and a distribution cabinet 204. The rectifier cabinet 202 can include numerous slots or positions 214 for accepting user selected rectifier modules. These slots 214 can include contacts which mate with corresponding contacts on the rectifier modules 215 (see FIG. 4). These contacts can be connected to corresponding terminals which can be included in a terminal panel or strip (not shown in FIGS. 3 and 4). Also, the rectifier cabinet 202 can include provisions 209 for adding a system controller, a front access panel 216, a cover 218 for a set of bus bars (to be discussed), and an AC entry 220 for the AC supply wires 208. As will be explained herein, the front access panel 216 can allow the user to open the rectifier cabinet 202 for terminating the AC supply wires 208 and for otherwise configuring the rectifier cabinet wiring. In one embodiment, the rectifier slots 214 can be near the bottom of the rectifier cabinet 202 although the slots 214 could be located near the top of the cabinet 202. In this case, the wiring compartment, the access door 216, and the AC entry 220 could be located near the bottom of the cabinet 202 instead of near the top. In the alternative, the AC supply wires 208 can be routed out through the bottom of the rectifier cabinet 202.

Similarly, the distribution cabinet 204 can include numerous slots or positions 224 for distribution modules, a DC wiring compartment 226, and a termination panel or strip 228. The distribution module slots can be positioned in a vertical line along the side of the cabinet 204 on which the accompanying rectifier cabinet 202 is positioned. The slots 214 can include contacts which may be connected to terminals on the terminal strip 228 and can mate with corresponding contacts on the distribution modules. This arrangement of the distribution module slots 224 leaves the wiring compartment 226 adjacent to the slots 224 with ample room to bring the DC wires 210 through the entry 230, turn them as required, and terminate them at the terminal strip 228. Indeed, the width of the DC wiring compartment 226 may be selected such that it allows the DC wire 210 with the largest bend radius to be routed to the terminal strip 228. As with the rectifier panel entry 220, the DC entry 230 may be located at the top of the cabinet 204 or at the bottom of the cabinet.

Moreover, the rectifier cabinet 202 and the distribution cabinet 204 may be strapped, bolted or otherwise coupled, together and, in one embodiment, this is done so that they may be easily separated, if desired. Thus, as shown in FIGS. 3 and 4, the rectifier slots 214 and distribution module slots 224 may be oriented so that the front of the rectifier modules and distribution modules are generally aligned with the front of the cabinets 202 and 204. Further, the slot contacts may be positioned near the back of the slots 224.

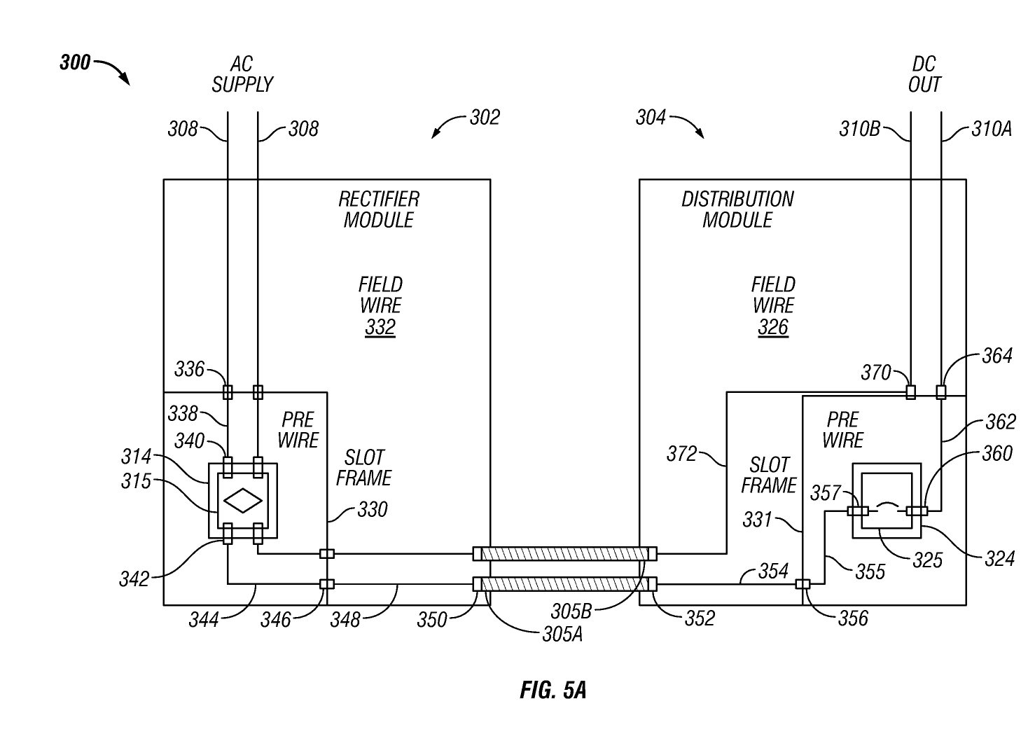

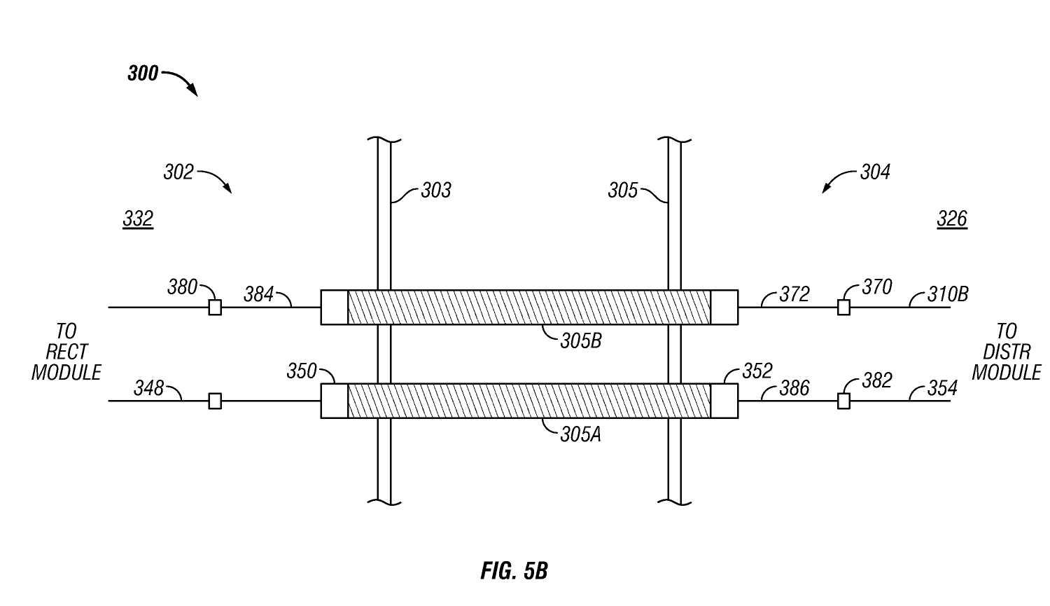

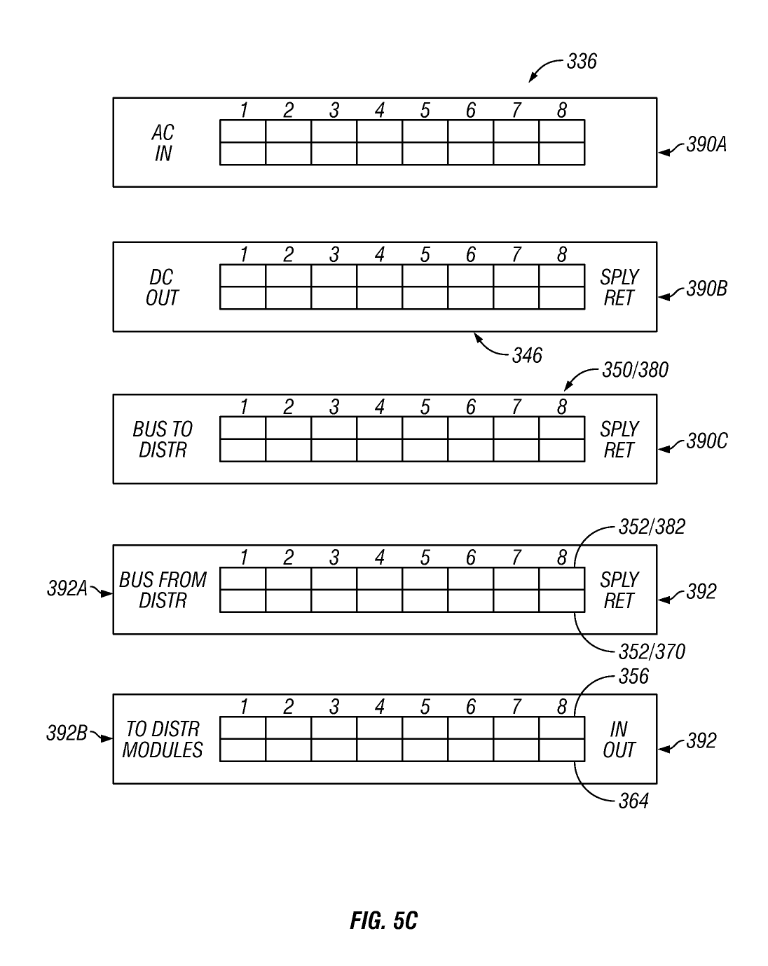

With reference now to FIG. 5, a schematic of another power system 300 constructed in accordance with one embodiment of the present invention is shown. The system 300 generally corresponds to the system 200 of FIGS. 3 and 4 and contains many corresponding components. More particularly, the rectifier cabinet 302, the distribution cabinet 304, the rectifier slots 314, and the distribution module slots 324 are illustrated. Additionally, FIG. 5 illustrates a rectifier module 315 and a distribution module 325 installed in their respective slots 314 and 324. FIG. 5 also illustrates that the cabinets 302 and 304 can be electrically connected by a pair of external conductors 305.

Furthermore, FIG. 5 illustrates the wiring associated with an embodiment of the present invention in which one single-phase rectifier module 315 can feed one distribution module 325. Of course, many more involved system configurations, or architectures, may be assembled with multiple phase power supplies 308 and with different numbers of rectifier modules 315 and distribution modules 325. As shown, the AC supply wires 308 enter the rectifier cabinet 302 and may be terminated in the field to a pair of terminals 336. These AC supply terminals 336 can be located in the wiring compartment 332 of the rectifier cabinet 302. From the AC supply terminals 336 a pair of pre-wired leads or pre-installed bus bars 338 can electrically connect the AC supply to the AC supply contacts 340 of the rectifier slot 314. Since the rectifier module 315 can have contacts 340 which mate with the slot contacts 340, FIG. 5 also illustrates that the AC supply can be electrically connected to the rectifier 315. On the output side of the rectifiers 315, another set of pre-wired leads or pre-installed bus bars 344 can connect the rectifier output contacts 342 to a pair of DC terminals 346. The DC terminals 346 (and the AC terminals 336) can be located on one or more terminal panels (or strips) in the wiring compartment 332. From the DC output terminals 346, a pair of field installed wires 348 can connect the output of the rectifier 315 to another pair of terminals 350.

Since the terminals 350 can communicate with the external conductors 305, the external terminals 350 may provide the rectifier DC output to devices external to the rectifier cabinet 302. FIG. 5 also shows that the pair of external conductors 305 can be connected to the external terminals 350. In one embodiment the conductors 305 can be copper bus bars although they could be wires or cables. In any case, the conductors 305 may be used to route the DC output of the rectifier 315 to one or more distribution modules 304 via another pair of terminals 352 on the distribution cabinet 304. In one embodiment, the external conductors 305 can be installed as part of the system 300 and near or on the back of the cabinets 302 and 304. However, provisions can be made such that the external conductors 305 can be added in the field as part of the installation process for the system 300.

Within the distribution module 304, the DC supply and return paths may separate. On the supply side of the DC circuit, a wire 354 (which in one embodiment can be installed in the field in the wiring compartment 326) carries the DC power to a DC supply terminal 356. From the DC supply terminal 356, a pre-wired lead 355 conveys the DC power to the contacts 357 of the distribution module slot 324 and distribution module 325. Via the mating contacts 357, the DC power flows to the distribution module 325. When the distribution module 325 is in a conducting state (e.g., the circuit breaker 325 is “made”) the DC power also flows to the second DC supply contact 360 of the distribution module 325 and distribution module slot 324. A pre-wired lead or pre-installed bus bar 362 conveys the power on to terminal 364. The DC supply wire 310A (which terminates on the DC supply terminal 360) then conveys the DC power to the facility equipment to be supplied power by the system 300. Of course, the DC circuit also includes a DC return wire 310B which conveys the DC current from the facility equipment to a DC return terminal 370. The terminals 356, 364, and 370 may be located on a terminal panel or strip similar to strip 228 of FIG. 3 at a location accessible via the front of the wiring compartment 326. From the return terminal 370, a pre-wired or pre-installed bus bar 372 may conduct the return DC current back to one of the terminals 352 to complete the return path to the rectifier 315 via the return bus bar 305B. Thus, the wiring 338, 344, 355, and 362 between the rectifier and distribution module slots 314 and 324 and their corresponding terminals 336, 346, 356, and 360 can be pre-wired.

Also, a portion of the return wiring 372 may be pre-wired. However, the wiring 308, 348, 354, 310A, and 310B in the wiring compartments 326 and 332 can be field configurable to allow the user to interconnect various combinations of AC power supplies 308, rectifier modules 315, distribution modules 325, and facility equipment. In the alternative, some of these conductors (e.g., wires 348 and 354) may be pre-wired or pre-installed into the system. Furthermore, the rectifiers 315 and distribution modules 325 may be selected by the user and even changed during the life of the system 300. Accordingly, the user may alter the configuration of the power system 300 by changing rectifiers 315, by changing distribution modules 325, by field re-wiring of the cabinets 302 and 304, by adding or subtracting cabinets 302 and 304, or by a combination of these options.

In another embodiment, additional terminals may be interposed between the external terminals 350 and 352 of the rectifier cabinet 302 and the distribution module 304, respectively, as shown by FIG. 5B. These additional terminals allow the wiring that leads to the external conductors 350 and 352 to also be pre-wired while still allowing the user to configure the cabinets 302 and 304 via the wiring 348, 354, and 310B in the wiring compartments 326 and 332. Such an embodiment may be used where it is desired for the bus bars 305 to be positioned where it might be impractical for the user to access the external terminals 350 and 352. More specifically, in some embodiments, the bus bars 305 may be positioned toward the back and near the bottom of the cabinets 302 and 304. A pair of terminals 380 can connect the bus bars 305 to the user configurable wires 348 in the rectifier cabinet 302. Similarly, the terminal 382 may connect the bus bar 305A to the user configurable wire 354 in the distribution module 304. Of course, the DC return terminal 370 and pre-wired DC return lead 372 may also serve a similar purpose as the DC supply terminal 382 and DC supply lead 386. For that matter, the DC return terminal 370 and DC return lead 372 may be dispensed with for those embodiments in which the external connectors 352 can be accessible by the user. Nonetheless, the intermediate terminals 370, 380, and 382 may be included in easily accessible termination panels or strips in the wiring compartments 326 and 332 of the cabinets 304 and 302 respectively (see FIG. 5C). Of course, appropriate labeling may be included on the various terminals such that for each terminal in the rectifier cabinet 302, the corresponding terminal in the distribution cabinet 304 may be positively identified by the user prior to configuring the wiring in the compartments 326 and 332.

FIG. 5A also schematically show that the bus bars 305 may extend into the cabinets 302 and 304. More specifically, the bus bars 305 are shown extending through the side walls 303 and 305 of the cabinets 302 and 304. The “external” connectors 350 and 352 are shown being internal to the cabinets 302 and 304. However, they may be deemed “external” connectors 350 and 352 in the sense that they allow electrical connectivity to devices external to their respective cabinets 302 and 304. Moreover, these connectors 350 and 352 may, but need not be, bus bar type terminals.

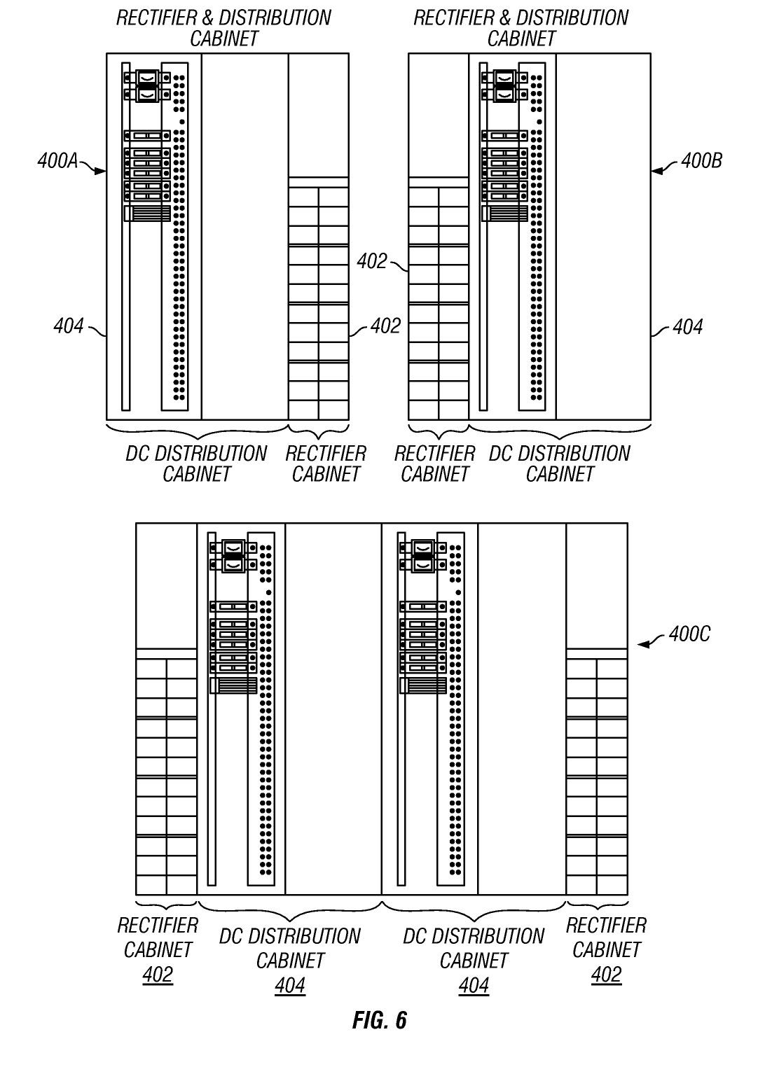

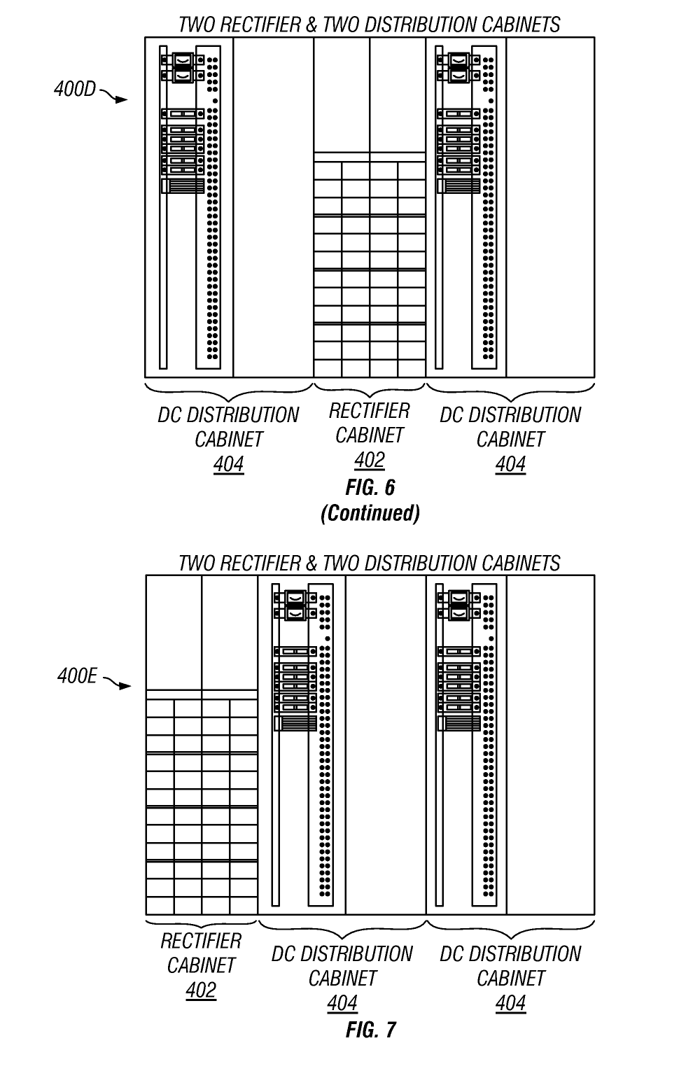

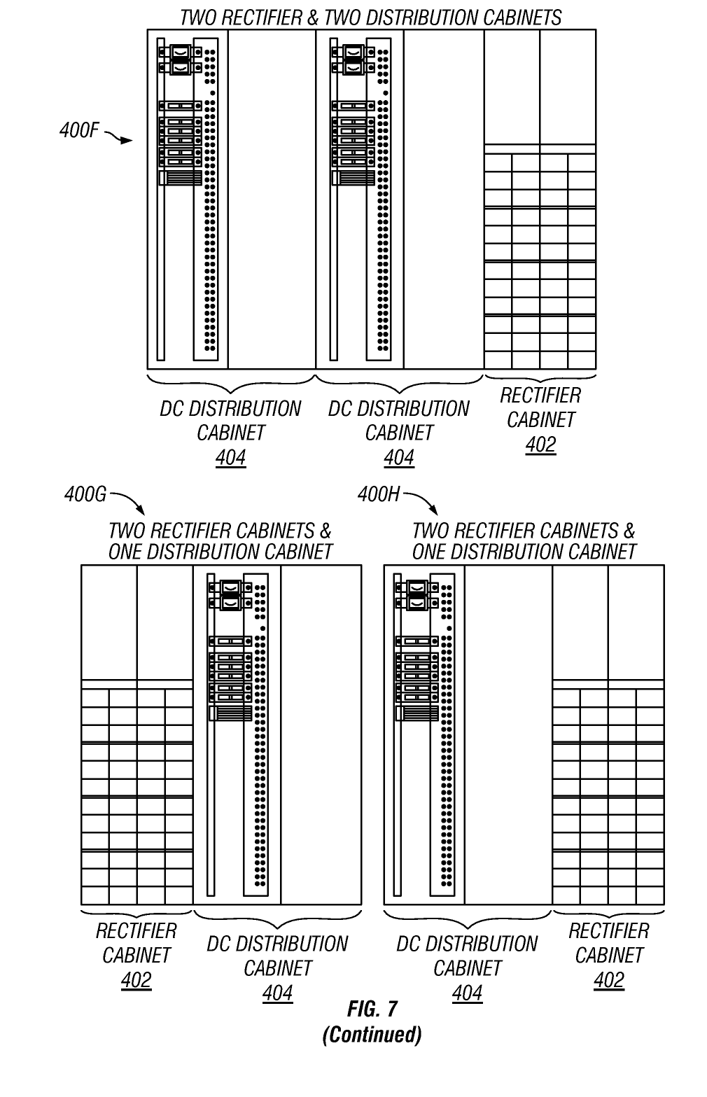

With reference now to FIGS. 6 and 7, a variety of systems 400 are illustrated which the user can configure using the rectifier and distribution cabinets 402 and 404 disclosed herein. For instance, FIG. 6 shows four exemplary configured systems 400A to 400D. System 400A includes a rectifier cabinet 402 and a distribution cabinet 404 to the left of the rectifier cabinet 402. Similarly, system 400B shows the distribution cabinet 404 to the right of the rectifier cabinet 402. Meanwhile systems 400C to 400H (see FIGS. 6 and 7) show embodiments with a plurality of rectifier cabinets 402 and distribution cabinets 404. Moreover, some systems 400 have differing numbers of rectifier cabinets 402 and distribution cabinets 404. These systems 400, of course, may be selected by the user and configured by extending the conductors 305, which can be the bus bar conductors 305 depicted of FIG. 5) between the various cabinets 402 and 404.

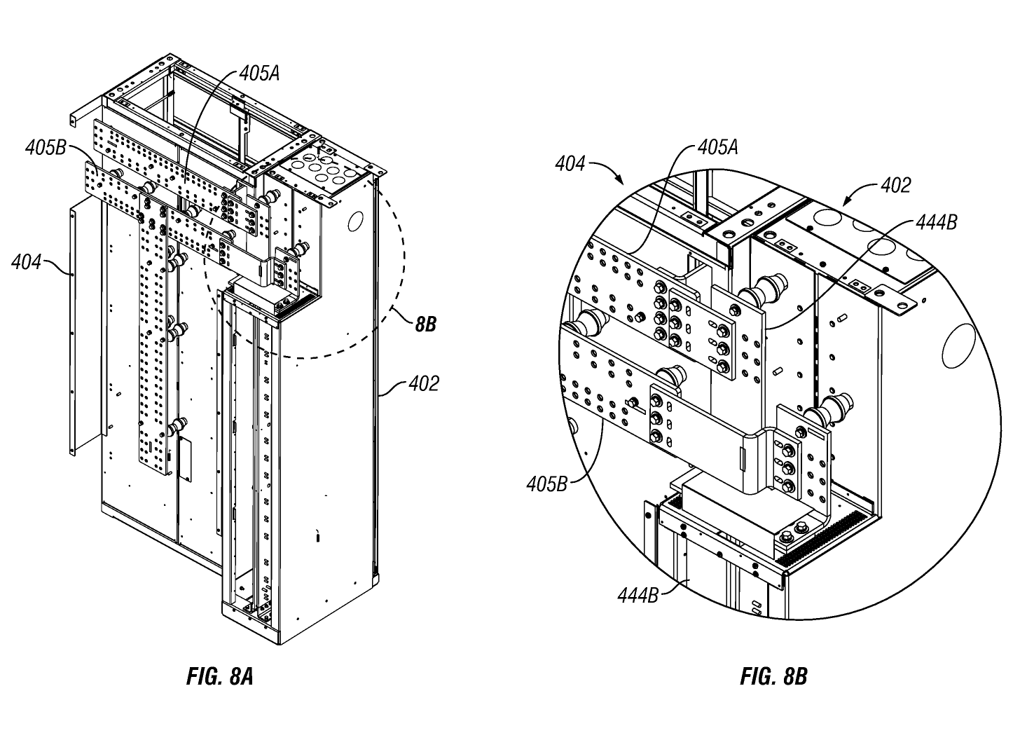

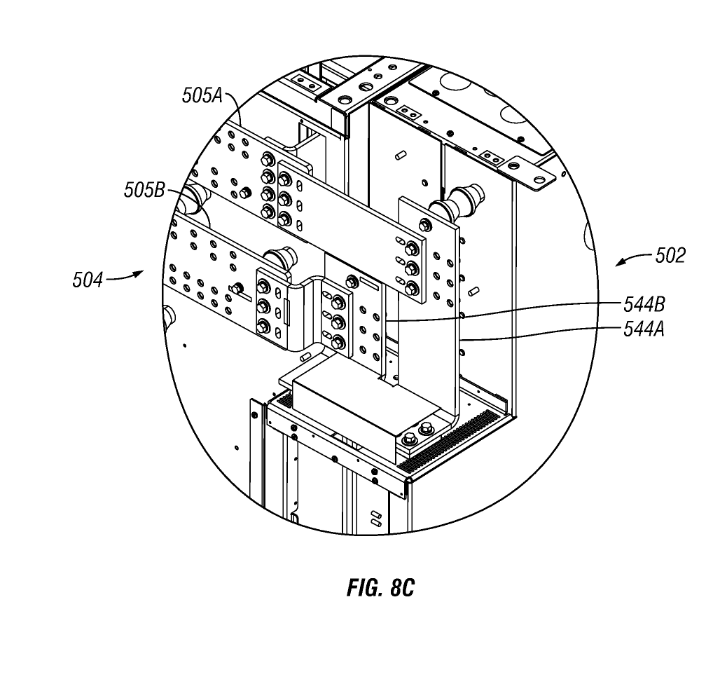

With regard now to FIGS. 8A-C additional embodiments are depicted. In FIGS. 8A-B a pair of bus bars 405A and 405B convey the DC power from the rectifier cabinet 402 to the distribution cabinet 404. More particularly, the pre-installed bus bars 444A and 444B connect the rectifier slots to the inter-cabinet bus bars 405A and 405B respectively. Of course, appropriate shielding, insulators, and covers (e.g., cover 218 of FIG. 3) can be provided to couple the bus bars to the cabinets. The inter-connecting bus bars 505 then convey the DC power to the distribution module 404 where the field installed wiring may be terminated. For instance, field wiring may be terminated on bus bar 405A for the load connections while the field wired returns may be terminated on bus bar 405B with pre-installed connections routing the power to and from the distribution modules.

Similarly, FIG. 8C illustrates another alternative embodiment in which the polarity of the inter-connecting bus bars has been reversed. Thus, while FIGS. 8A-8B show a negative output bus bar 405A and a negative return bus bar 405B, FIG. 8C shows that bus bar 505A may be a positive output and that bus bar 505B may be a negative return. Again, appropriate shielding and insulation can be provided. Note that in the embodiments shown by FIGS. 8A-C, the circuit illustrated by FIG. 5A may be simplified. In particular, the wires or conductors 348, 354, and 372 and the associated terminals 346 and 356 may be omitted since the bus bars 405 and 505 complete these portions of the circuit.

Thus, in some embodiments there can be a one-to-one correspondence between the rectifier cabinets and the distribution cabinets. In other embodiments, the number of rectifier cabinets and distribution module cabinets can differ. Furthermore, the rectifier module slots and distribution module slots can correspond to each other but need not. Additionally, the DC power provided by the rectifiers can be conveyed to the distribution modules via a pair of bus bars that carries the entire output of the rectifier cabinet(s). Moreover, because the embodiments of the present invention allow the rectifiers to be separated from the distribution modules, the overall operating temperature of the rectifiers and distribution module can be reduced. In yet another alternative embodiment, the capacity provided by the rectifiers in the rectifier cabinet(s) can match the capacity of the distribution modules in the in the distribution cabinet(s). However, the capacity of the rectifier cabinets and the distribution modules need not match. Indeed, one cabinet can have more capacity than the other cabinet.

The practice of the present invention provides users with systems and methods for supplying power to many facilities, particularly those facilities with large DC current requirements (e.g., 2000 to 6000 amps). Moreover, embodiments of the present invention provide highly reliable and fully configurable power systems for wire line and wireless applications. Additionally, the corresponding system architectures can be configured for up to 10,000 amps capacity and more in a user flexible, practical, and simple field procedure. These highly configurable systems allow easy expansion to meet the changing needs of many facilities. Moreover, the plug and play system architectures of these systems minimizes, if not eliminates cable congestion.

Moreover, the power systems disclosed herein may be configured in a wide variety of manners to meet the power requirements and potential growth profiles of many different facilities. For instance, in one embodiment a 2500 amp system is provided in a 12 inch wide rectifier cabinet which can include exemplary 100 amp and 150 amp, 48 VDC, “X Series” rectifiers which are available from Valere Power of Richardson, TX. Furthermore, the systems disclosed herein may accommodate the installation of standard distribution equipment such as GJ, GS, and bullet style breakers, as well as TPL fuses while also providing ample space for bending and terminating large cables. Of course, the systems may also include a battery termination panel with an optional low voltage disconnect.

Further, in embodiments that include a system controller, the systems can allow for thorough and user-friendly monitoring and diagnostics that help reduce the time and cost of installing the systems. Likewise, these systems reduce the number, length, and cost of maintenance visits to the facilities where the systems are installed. Thus systems that include controllers may also provide remote interfaces for managing the system thereby improving the productivity of the user's work force. Accordingly, the embodiments of the present invention result in reliable, cost-effective, and trouble free power systems.

It is understood that the present invention can take many forms and embodiments. Accordingly, several variations may be made in the foregoing without departing from the spirit or the scope of the invention. For example, while FIG. 5 shows a relatively simple, one rectifier module, one distribution module, single phase circuit, the present invention allows the circuit to be expanded with additional rectifiers, distribution modules, and phases.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A power distribution system, the system comprising:
a rectifier cabinet including a plurality of slots for accepting rectifiers and a side wall;
a distribution cabinet including a plurality of slots for accepting distribution modules and at least one side wall adjacent to the side wall of the rectifier cabinet; and
at least a pair of conductors, each conductor being coupled to the cabinets, one of the conductors being adapted to terminate a first wire connected to a rectifier slot and to terminate a second wire connected to a distribution module slot, the other conductor being adapted to complete a direct current return path to the rectifier cabinet.

2. The system of claim 1 wherein the distribution cabinet further comprises a top defining a wire access for routing a direct-current wire between the system and a power-using facility.

3. The system of claim 1 wherein the distribution cabinet further comprises a bottom defining a wire access for routing a direct-current wire between the system and a power-using facility.

4. The system of claim 1 wherein the side wall of the rectifier is on the right side of the rectifier cabinet as seen from the front of the cabinets.

5. The system of claim 1 wherein one of the conductors further comprises a bus bar.

6. The system of claim 5 wherein the bus bar further comprises a return bus bar.

7. The system of claim 1 wherein at least a portion of the conductors are near the back of the cabinets.

8. The system of claim 1 wherein the distribution cabinet further comprises a top defining an entry for routing an alternating-current wire between the system and a power-using facility.

9. The system of claim 1 wherein the rectifier cabinet further comprises a top defining an entry for routing an alternating-current wire between the system and a power-using facility.

10. The system of claim 1 further comprising at least one of another rectifier cabinet or another distribution cabinet.

11. A rectifier cabinet for use with a distribution cabinet comprising:
a plurality of slots for accepting rectifiers;
a first pair of terminals for a pair of alternating current wires; and
a second pair of terminals for a pair of direct current wires; the terminals being connected to the rectifier slot, the rectifier cabinet being connectable to an upstanding rectifier cabinet to the side thereof.

12. The rectifier cabinet of claim 11 further comprising a wiring compartment in the cabinet.

13. The rectifier cabinet of claim 12 wherein the wiring compartment is above the rectifier slots.

14. The rectifier cabinet of claim 11 further comprising a termination panel including the terminals.

15. The rectifier cabinet of claim 11 further comprising a front access panel, the terminals being accessible via the front access panel.

16. The rectifier cabinet of claim 11 further comprising a top panel defining an entry for routing the alternating current wires into the rectifier cabinet.

17. The rectifier cabinet of claim 11 further comprising a bottom panel defining an entry for routing the alternating current wires into the rectifier cabinet.

18. The rectifier cabinet of claim 11 further comprising a back wall and a pair of external terminals on the back wall, the external terminals being adapted in such a manner as to allow the direct current terminals to be connected to the external terminals.

19. A distribution cabinet for use with a rectifier cabinet comprising:
a plurality of slots for accepting distribution modules;
a terminal for a direct current wire, the terminal being connected to a distribution module slot; and
a terminal for completing a direct current return path to the rectifier cabinet, the distribution cabinet being connectable to an upstanding rectifier cabinet to the side thereof.

20. The distribution cabinet of claim 19 further comprising a battery distribution bay connected to at least one of the distribution modules.

21. The distribution cabinet of claim 19 further comprising a wiring compartment in the cabinet.

22. The distribution cabinet of claim 21 wherein the wiring compartment is adjacent to the rectifier slots.

23. The distribution cabinet of claim 19 further comprising a termination panel including the pair of terminals.

24. The distribution cabinet of claim 19 further comprising a front access panel, the return terminal and the pair of terminals being accessible via the front access panel.

25. The distribution cabinet of claim 19 further comprising a top panel defining an entry for routing the direct current wires into the distribution cabinet.

26. The distribution cabinet of claim 19 further comprising a bottom panel defining an entry for routing the direct current wires into the distribution cabinet.

27. The distribution cabinet of claim 20 further comprising a back wall and a pair of external terminals on the back wall, the external terminals being adapted in such a manner as to allow the return terminal and the pair of terminals to be connected to the external terminals.
